(19) United States
(12) Patent Application Publication
(10) Pub. No.: US 2008/0114975 A1
(43) Pub. Date: May 15, 2008

(54) METHOD AND PROCESSING SYSTEM FOR NESTED FLOW CONTROL UTILIZING PREDICATE REGISTER AND BRANCH REGISTER

(76) Inventor: Hsueh-Bing Yen, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/558,459

(22) Filed: Nov. 10, 2006

(51) Int. Cl. G06F 9/30

(52) U.S. Cl. 712/233; 712/E09.016

(57) ABSTRACT

A method for nested flow control is disclosed. The method includes providing a predicate register and a branch register; receiving a plurality of instructions including flow control instructions; storing a depth level with the branch register each time a flow control instruction is fetched or decoded or executed; setting the predicate register according to an evaluation result of the flow control instruction; and executing instructions following the flow control instruction according to the predicate register and the branch register.

### BACKGROUND OF THE INVENTION

1. Field of the Invention

The present invention relates generally to a method and device for a nested flow control, and more particularly, to a method and processing system for a nested flow control according to a predicate register and a branch register.

2. Description of the Prior Art

In traditional prior art flow control systems, such as in a SIMD, or single instruction multiple data, processor, there are many advantages and many disadvantages. For example, it is difficult to handle nested flow control for all independent data in the SIMD environment. However, for many applications, such as but not limited to, graphics related applications, the traditional flow control of SIMD's brother, MIMD, or multiple instruction multiple data processors is not necessary as it leads to a significant waste of hardware resources, significantly more expensive to manufacture, and more difficult to control and the end result of handling the nested flow control, especially for said graphics applications that lend themselves well to MIMD architectures, doesn't address the root of the difficulties.

The operation of SIMD and MIMD and other are all well known to a person of average skill in the pertinent art, therefore, additional details are omitted for the sake of brevity. It is also well known that methods are needed to improve nested flow control in the MIMD computing system. Therefore, it is apparent that new and improved methods and devices are needed.

### SUMMARY OF THE INVENTION

It is therefore one of the objectives of the claimed invention to provide a method and processing system for nested flow control according to a predicate register and a branch register to solve the above mentioned problems.

According to an embodiment of the claimed invention, a method for nested flow control is disclosed, the method includes providing a predicate register and a branch register; receiving a plurality of instructions including flow control instructions; storing a depth level with the branch register each time a flow control instruction is fetched or decoded or executed; setting the predicate register according to an evaluation result of the flow control instruction; and executing instructions following the flow control instruction according to the predicate register and the branch register.

According to an embodiment of the claimed invention, a method for nested flow control is disclosed. The method includes providing a predicate counter and a depth level counter; receiving a plurality of instructions including flow control instructions; storing a depth level with the depth level counter each time a flow control instruction is fetched or decoded or executed; setting the predicate counter according to at least one of a predetermined number and the depth level counter according to an evaluation result of the flow control instruction; and executing instructions following the flow control instruction according to the predicate counter and the depth level counter.

According to an embodiment of the claimed invention, a processing system having nested flow control is disclosed. The claimed invention includes an instruction buffer for receiving and storing a plurality of instruction including flow control instructions; at least a branch register, for storing a depth level each time a flow control instruction is fetched or decoded or executed; a processing unit, including: at least a predicate register each representing an execution status of a corresponding depth level; and an execution unit, for executing the instructions, wherein the predicate register is set according to an evaluation result of the flow control instruction executed by the execution unit and a current depth level; a flow control unit, for controlling the execution unit to execute instructions following the flow control instruction according to the predicate register.

According to an embodiment of the claimed invention, a processing system having nested flow control is disclosed. The claimed invention includes a processing system with a predicate register, for storing a predicate counter; an instruction fetch/decode unit, for receiving, storing, and decoding a plurality of instructions including flow control instructions; a depth level register, for storing a depth level counter; a flow control unit, for tracking a depth level with the depth level counter each time a flow control instruction is fetched or decoded or executed; and an execution unit, for setting the predicate counter according to at least one of a predetermined number and the depth level counter according to an evaluation result of the flow control instruction and for executing instructions following the flow control instruction according to the predicate counter and the depth level counter.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram according to a first embodiment of the present invention not supporting an early-out option.

FIG. 2 is a flowchart illustrating a method according to the first embodiment of the present invention shown in FIG. 1 not supporting an early-out option.

FIG. 3 is a block diagram according to a first embodiment of the present invention supporting an early-out option.

FIG. 4 is a flowchart illustrating a method according to the first embodiment of the present invention shown in FIG. 3 supporting an early-out option.

FIG. 5 is a block diagram according to a second embodiment of the present invention not supporting an early-out option.

FIG. 6 is a flowchart illustrating a method according to the second embodiment of the present invention shown in FIG. 5 not supporting an early-out option.

FIG. 7 is a block diagram according to a second embodiment of the present invention supporting an early-out option.

FIG. 8 is a flowchart illustrating a method according to the second embodiment of the present invention shown in FIG. 7 supporting an early-out option.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” The terms “couple” and “couples” are intended to mean either an indirect or a direct electrical connection. Thus, if a first device couples to a second device, that connection may be through a direct electrical connection, or through an indirect electrical connection via other devices and connections.

In the following description, the term “flow control instruction” could be referred to as an entrance flow control instruction (e.g., IF, LOOP, REP, BREAK, or CALL), or a termination flow control instruction (e.g., ELSE, ENDIF, ENDLOOP, ENDREP, or RET). The IF flow control instruction and the ELSE flow control instruction are used to define a block including instructions to be executed when an evaluation result of the IF flow control instruction is logic TRUE; the ELSE flow control instruction and the ENDIF flow control instruction are used to define a block including instructions to be executed when the evaluation result of the IF flow control instruction is logic FALSE; the LOOP/REP flow control instruction and the ENDLOOP/ENDREP flow control are used to define a block including instruction(s) to be executed according to an iteration number; the BREAK flow control instruction is used for breaking a block defined by LOOP and ENDLOOP flow control instructions or a block defined by REP and ENDREP flow control instructions; and the CALL flow control instruction and RET flow control instruction are used to define a block including instructions belonging to a subroutine to be called. Please note that the present invention is not limited to above exemplary flow control instruction types. That is, other flow instruction types are also supported by the present invention disclosed hereinafter.

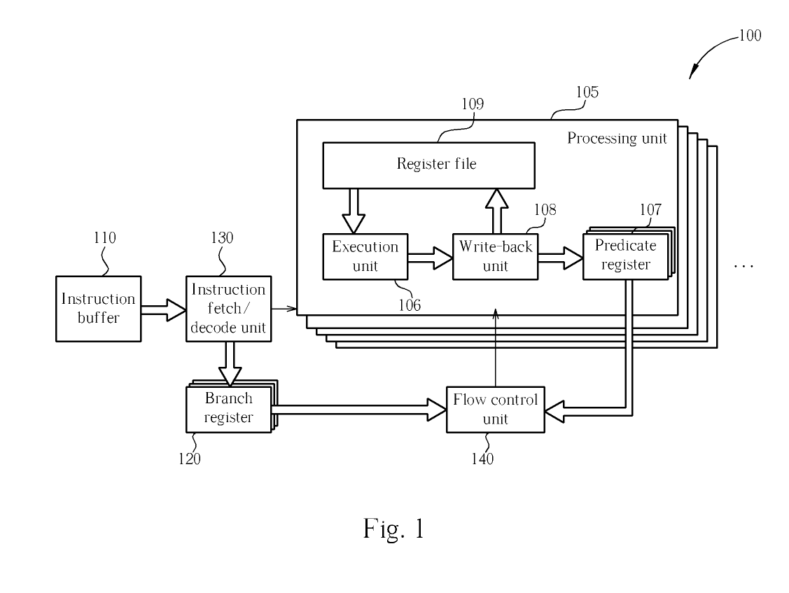

Please refer to FIG. 1. FIG. 1 is a block diagram according to a first embodiment of the present invention not supporting an early-out option. A processing system 100 is disclosed. In FIG. 1, the small arrow symbol represents a control path, which controls which operation to be executed and the execution result to be written into a specific register, while the large arrow symbol represents a data path, which contains instructions and data. The processing system 100 supports nested flow control and includes an instruction buffer 110 for receiving and storing a plurality of instructions (not shown) including flow control instructions (i.e., entrance flow control instructions and termination flow control instructions). The processing system 100 also includes at least a branch register 120, for storing a depth level each time a flow control instruction is processed by the instruction fetch/decode unit 130. Additionally, at least a processing unit 105 is coupled to the instruction buffer 110. The processing unit 105 comprises at least a predicate register 107, an execution unit 106, a write-back unit 108 and a register file 109. The execution unit 106 is for executing the plurality of instructions buffered in the instruction buffer 110. In this embodiment, a value of the predicate register 107 is set according to an evaluation result of the flow control instruction that is executed by the execution unit 106. Additionally, a flow control unit 140 is coupled to the branch register 120 and the predicate register 107 (Please note that the predicate register 107 is disposed within the processing unit 105 as shown in FIG. 1). The flow control unit 140 is utilized for controlling the execution unit 106 to execute the instructions that follow the flow control instruction according to the predicate register 107 and to control the write-back unit 108 to write the execution result into the register file 109. In a case where the flow control unit 140 masks the register file 109 by masking register file write enable, the write-back unit 108 is stopped from writing data into the register file 109.

Additionally, the branch register 120 of the processing system 100 stores the depth level each time a flow control instruction is processed by the instruction fetch/decode unit 130, an entrance flow control instruction, such as an IF flow control instruction, makes the depth level stored in the branch register 120 shift or increase forward, and a termination flow control instruction, such as an ENDIF flow control instruction, makes the depth level stored in the branch register 120 shift or decrease backward. Note that in an embodiment of the present invention, each type of flow control instruction is assigned with a corresponding branch register 120. In other words, branch flow control instructions can have a ‘BRANCH’ branch register, loop flow control instructions can have a ‘LOOP’ branch register, and so on. These examples are easily understood to those of average skill in this art, and therefore additional details after herein omitted for the sake of brevity.

In the present invention, predicate registers 107 are implemented for recording evaluation results of flow control instructions corresponding to different depth levels indexed by the branch register 120 corresponding to a specific flow control instruction type. For example, when a specific flow control instruction is executed, a specific depth level corresponding to the specific flow control instruction is recorded in the branch register 120, and the predicate register 107 stores a logic FALSE corresponding to the specific depth level according to an evaluation result of the specific flow control instruction. As to a block between two flow control instructions (e.g., between IF flow control instruction and ELSE flow control instruction), containing instructions executed at the specific depth level and corresponding to the predicate register 107 storing logic FALSE for the specific depth level, any results generated from execution of the instructions within the block are not written into the register file 109, which is equivalent to ignoring the execution of the block. However, when a specific flow control instruction is executed, a specific depth level corresponding to the specific flow control instruction is recorded in the branch register 120, and the predicate register 107 stores logic TRUE corresponding to the specific depth level according to an evaluation result of the specific flow control instruction. As to a block between two flow control instructions (e.g., between ELSE flow control instruction and ENDIF flow control instruction), containing instructions executed at the specific depth level and corresponding to the predicate register 107 storing logic TRUE for the specific depth level, any results generated from execution of the instructions within the block are written back to the register file 109 for following data processing. In other words, the flow block, between two flow control instructions and containing instructions can be ignored at a specific depth level, is marked/indicated by the predicate register 107 storing logic FALSE for the specific depth level. Therefore, referring to the register value stored in the predicate register 107 for a specific depth level when executing instructions at the specific depth level indexed by the corresponding branch register 120, the disclosed nested flow control scheme can easily identify if the execution results of the instructions are written back to the register file 109 or dumped, thereby solving the nested flow control problem in the conventional SIMD processor.

Please note, the flow control unit 140 will control the execution unit 106 to execute instructions following the flow control instruction when the evaluation result of the instruction indicates that the flow control instruction is satisfied. In other words, for example, when the conditions of an IF flow control instruction are satisfied, in other words, the IF flow control instruction evaluates to logic TRUE, then the instructions directly following the IF flow control instruction will be executed up to the corresponding termination flow control instruction. In the case of this example, with IF as the flow control instruction, then for example, ELSE and ENDIF are the corresponding termination flow control instructions.

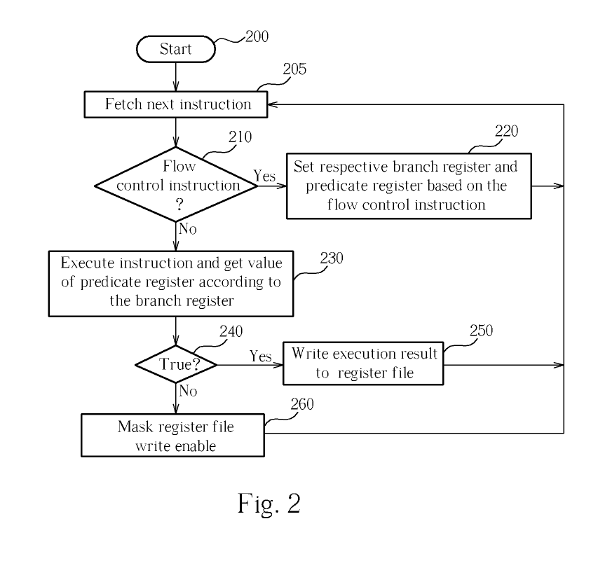

Please refer to FIG. 2. FIG. 2 is a flowchart illustrating a method according to the first embodiment of the present invention shown in FIG. 1 not supporting an early-out option. The method of the present invention comprises the following steps:

Step 200: Start.

Step 205: Fetch next instruction

Step 210: Is the fetched instruction a flow control instruction? If yes, then go to step 220. If no, then go to step 230.

Step 220: Set respective branch register and predicate register based on the flow control instruction. Go to step 205.

Step 230: Execute instruction and get value of predicate register according to the branch register.

Step 240: Is the retrieved value of the predicate register corresponding to logic True? If yes, go to step 250. If no, go to step 260.

Step 250: Write result to a register file. Go to step 205.

Step 260: Mask a register file write enable. Go to step 205.

To further illustrate the operation of the present invention, please continue to refer to FIG. 1 and FIG. 2 along with the following textual description of the present inventions flow. The flow begins with step 200. Next, in step 205 the next instruction is fetched using a combination of the instruction buffer 110 and the instruction fetch/decode unit 130 as shown in FIG. 1. Next, in step 210, if the instruction is not a flow control instruction, then the invention, for example, a processing system or other similar computational device, handles the non-flow control instruction in the well-known way by continuing to step 230. As this is well known to having average skill in this art, further details are omitted hereinafter for the sake of brevity. If the fetched instruction is a flow control instruction, then in step 210 the flow goes to step 220. In step 220, the present invention sets respective branch register 120 and predicate register 107 based on the flow control instruction and then continues to step 250 to fetch the next instruction. As mentioned above, the branch register 120 updates the recorded depth level in response to execution of the flow control instruction, and then an evaluation result of the flow control instruction corresponding to the updated depth level is stored into the predicate register 107, thereby indicating whether results of the following instructions are written back to the register file 109.

Returning to step 210, when the current instruction, being decoded by the instruction fetch/decode unit 130 is not a flow control instruction, then the present invention continues to step 230. In step 230, the instruction is executed and the value of the predicate register 107 indexed by the value of the branch register 120 is retrieved. Next, in step 240, if the value of predicate register is evaluated to logic TRUE, then next in step 250 the result of the current instruction is written to the register file 109 using a combination of the flow control unit 140 and the write-back unit 108. If, however, the value of predicate register is logic FALSE, then in step 260, the register file write enable is masked under the control of the flow control unit 140 and no result is written back to the register file 109. Finally, the flow returns to step 205 to fetch the next instruction.

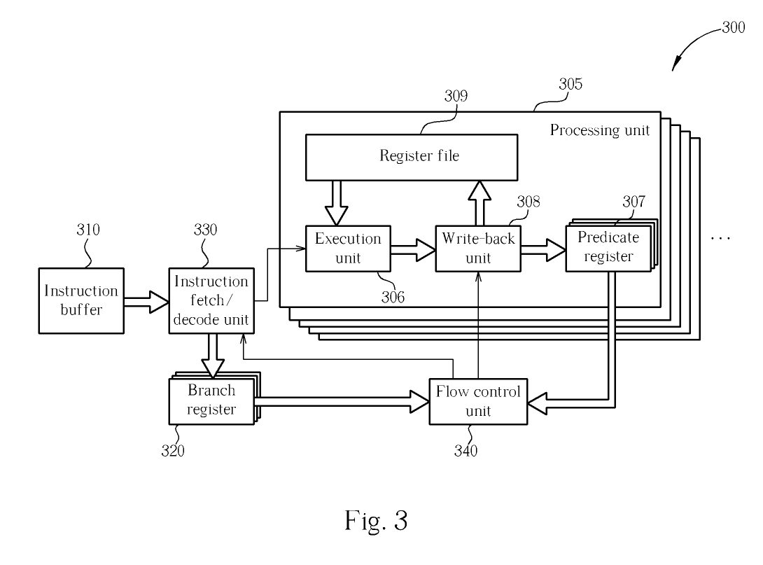

Please refer to FIG. 3. FIG. 3 is a block diagram according to a first embodiment of the present invention supporting an early-out option. FIG. 3 and FIG. 1 are very much identical but with a minor difference. Please note that at least a specific flow control instruction of the flow control instructions buffered in the instruction buffer 110 can include a target address. The target address is used in conjunction with a flow control instruction. For example, when an IF flow control instruction evaluates to logic FALSE, then an instruction at the target address (i.e., the ELSE is present or the ENDIF) will be executed next by the execution unit. The target address can also be utilized to implement an early-out programming strategy. For example, the target address can be the address of the next instruction executed by the execution unit is when an early-out condition is met. The early-out condition can be many conditions. The present invention does not provide any limitation in this regard. The preceding is offered by way of example and not limitation to the present invention. In FIG. 3, a flow control path is established between the flow control unit 340 and the instruction fetch/decode unit 330. This control path facilitates the above early-out option. For example, suppose that a current flow control instruction has been executed. If there are N processing units 305, and all N processing units 305 evaluate respective predicate registers indexed by the branch register 320 as logic FALSE, and then it is not necessary to process the following instructions until the instruction with the corresponding flow control termination instruction is fetched, for example, an ELSE flow control instruction, or simply, an ENDIF flow control instruction. The implementation of the early-out option requires insignificant hardware but it provides significant increases in efficiency and performance. All other components of FIG. 1 and FIG. 3 having the same name have identical functions and therefore duplicate descriptions have herein omitted for the sake of brevity. Simply refer to the FIG. 1 section earlier for detailed information.

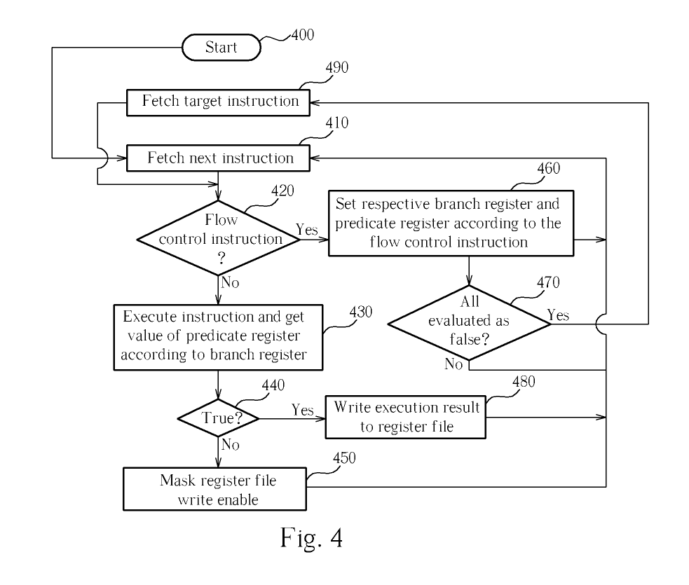

Please refer to FIG. 4. FIG. 4 is a flowchart illustrating a method according to the first embodiment of the present invention shown in FIG. 3 supporting an early-out option. FIG. 4 begins at step 400 with the beginning of the flow. Next, in step 410, a new instruction is fetched. Then in step 420 it is determined if the newly fetched instruction is a flow control instruction. If yes, then go to step 460. If the new instruction is not a flow control instruction then the flow continues to step 430. In step 430, when the instruction is not a flow control instruction, the instruction is executed, and the present invention retrieves the value of the predicate register indexed by the value of the branch register. Steps 440, 450, and 480 are identical in function to steps 240, 250, and 260 of FIG. 2 therefore the details are not repeated here. Returning to step 420, in the case of a flow control instruction, step 460 is executed and step 460 sets the respective branch register 320 in response to execution of the flow control instruction and predicate register 307 according to an evaluation result of the flow control instruction. Next, in step 470, the early-out option is implemented. If all processing units evaluate respective predicate registers for a specific depth level indexed by the branch register 320 to logic FALSE then continue to step 490 to fetch the target instruction according to the target instruction bits (recall these bits are included with the encoding fetch instruction as needed) or in step 470, if not all of the processing units evaluate the respective predicate registers to logic FALSE, then continue to step 410 to fetch the next instruction.

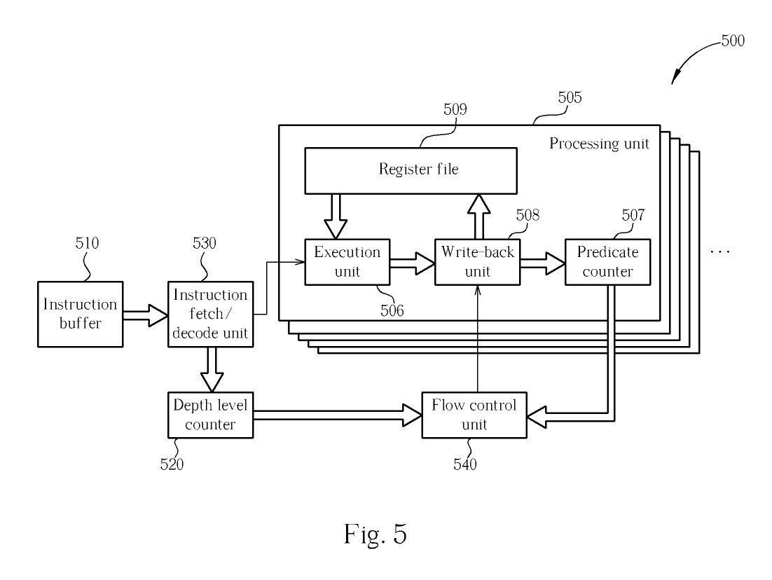

Please refer to FIG. 5. FIG. 5 is a block diagram according to a second embodiment of the present invention not supporting an early-out option. In a second embodiment of the present invention, a processing system 500 having nested flow control includes a predicate counter 507, for storing a predicate counter value (not shown); an instruction fetch/decode unit 530, for receiving, storing, and decoding a plurality of instructions including flow control instructions delivered from the instruction buffer 510; a depth level counter 520, coupled to the instruction fetch/decode unit 530, for storing a depth level counter value (not shown); a flow control unit 540, coupled to the depth level counter 520 and coupled to the predicate counter 507, for tracking a depth level with the depth level counter value each time a flow control instruction is fetched, decoded, or executed; and an execution unit 506, for setting the predicate counter value stored in the predicate counter 507 according to at least one of an evaluation result of the flow control instruction fetched by the instruction fetch/decode unit 530 and executed by the execution unit 506 and the depth level counter value stored in the depth level counter 520 and for executing instructions following the flow control instruction according to the predicate counter value stored in the predicate counter 507.

FIG. 5 is almost identical to FIG. 1, however, FIG. 1's branch register 120 is replaced by FIG. 5's depth counter 520, and FIG. 1's predicate register 107 is replaced by FIG. 5's depth counter 520. Specifically, the depth counter 520 is used for storing a depth level value that indicates the current level of nesting depth. Additionally, the small arrow symbol represents a control path, which controls which operation to be executed and the execution result to be written into a specific register, while the large arrow symbol represents a data path, which contains instructions and data.

In this embodiment, the processing system 500 includes the execution unit 506 for setting the predicate counter value stored in the predicate counter 507 each time the execution unit 506 executes a flow control instruction; and the execution unit 506 sets the depth level counter value stored in the depth level counter 520 each time a flow control instruction is executed by the execution unit 506.

More specifically, the predicate counter value is initially set by a predetermined number, for example, zero. In this embodiment, an instruction is fetched, decoded, or executed when the predicate counter value is equal to the predetermined number (i.e., 0). The depth level counter value is referred to for updating the predicate counter value when a specific condition is met. Many examples of setting the predicate counter value stored in the predicate counter 507 are illustrated below. However, these are for illustrative purposes and are not meant to be limitations of the present invention.

ELSE Flow Control Instruction:

The execution unit 506 of the processing system 500 sets the predicate counter value stored in the predicate counter 507 each time an ELSE flow control instruction (i.e., a termination flow control instruction) corresponding to the IF flow control instruction (i.e., an entrance flow control instruction) is executed by the execution unit 506. In this case, several different things occur. First, the predicate counter value is set to the depth level counter value when the current predicate counter value equals zero; or the execution unit 506 sets the predicate counter value to zero when the predicate counter value equals the depth level counter value; or the execution unit 506 maintains the predicate counter value to be the same value when the predicate counter value does not equal zero and the predicate counter value does not equal the depth level counter value.

ENDIF Flow Control Instruction:

The execution unit 506 of the processing system 500 sets the predicate counter value stored in the predicate counter 507 each time an ENDIF flow control instruction (i.e., a termination flow control instruction) corresponding to the IF flow control instruction (i.e., an entrance flow control instruction) is executed, wherein the execution unit 506 sets the predicate counter value to zero when the predicate counter value equals the depth level counter value; or the execution unit 506 maintains the predicate counter value to be the same value when the predicate counter value does not equal the depth level counter value.

ENDLOOP/ENDREP Flow Control Instruction:

The execution unit 506 of the processing system 500 can set the predicate counter value stored in the predicate counter 507 each time an ENDLOOP or an ENDREP termination instruction (i.e., a termination flow control instruction) corresponding to the LOOP flow control instruction or REP flow control instruction (i.e., an entrance flow control instruction) is executed by the execution unit 506. More Specifically, the execution unit 506 sets the predicate counter value to zero when the predicate counter value equals the depth level counter value, or the execution unit 506 maintains the predicate counter value to be the same value when the predicate counter value does not equal the depth level counter value.

RET Flow Control Instruction:

The execution unit 506 of the processing system 500 can set the predicate counter value stored in the predicate counter 507 each time a RET termination instruction (i.e., a termination flow control instruction) corresponding to the CALL flow control instruction (i.e., an entrance flow control instruction) is executed by the execution unit 506. More specifically, the execution unit 506 can set the predicate counter value to zero when the predicate counter value equals the depth level counter value, or the execution unit 506 maintains the predicate counter value to be the same value when the predicate counter value does not equal the depth level counter value.

IF Flow Control Instruction:

The execution unit 506 of the processing system 500 can set the predicate counter value stored in the predicate counter 507 each time an IF flow control instruction (i.e., an entrance flow control instruction) is executed by the execution unit 506. More specifically, the execution unit 506 sets the predicate counter value to zero when the original predicate counter value equals to zero and the evaluation result of the IF flow control instruction is logic TRUE. Or the execution unit 506 sets the predicate counter value to currently recorded depth level counter value when the original predicate counter value equals to zero and the evaluation result of the IF flow control instruction is logic FALSE. Or the execution unit 506 maintains the predicate counter value to be the same value when the original predicate counter value is not equal to zero.

LOOP/REP Flow Control Instruction:

The execution unit 506 of the processing system 500 can set the predicate counter value stored in the predicate counter 507 of the present invention each time a LOOP or a REP flow control instruction (i.e., an entrance flow control instruction) is executed by the execution unit 506. More Specifically, the execution unit 506 can set the predicate counter value to zero when an iteration number is not zero or the execution unit 506 sets the predicate counter value to equal the depth level counter value when the iteration number is equal to zero.

BREAK Flow Control Instruction:

The execution unit 506 of the processing system 500 sets the predicate counter value each time a BREAK flow control instruction (i.e., an entrance flow control instruction), which breaks a LOOP/ENDLOOP or REP/ENDREP block, is executed by the execution unit 506. More specifically, when a non-conditional BREAK flow control instruction is executed, the predicate counter value is set to equal the depth level counter value when the predicate counter equals zero, or the predicate counter is maintained at the same value when the predicate counter value is not equal to zero. Additionally, when a conditional BREAK flow control instruction is executed, the predicate counter is set to zero when the predicate counter equals zero and the evaluation result of the conditional BREAK flow control instruction is logic FALSE, or the predicate counter is set to the depth level counter value when the predicate counter equals zero and the evaluation result of the conditional BREAK flow control instruction is logic TRUE, or the predicate counter is maintained at the same value when the predicate counter value is not equal to zero.

CALL Flow Control Instruction:

The execution unit 506 of the processing system 500 sets the predicate counter value each time a conditional CALL flow control instruction (i.e., an entrance flow control instruction), which decides to enter a subroutine according to some conditions, for example, some registers are equal to zero, is executed by the execution unit 506. More specifically, the execution unit 506 sets the predicate counter value to zero when the original predicate counter value equals zero and the evaluation result of the conditional call flow control instruction is logic TRUE. Or the execution unit sets the predicate counter value to current depth level counter value when the original predicate counter value equals zero and the evaluation result of the conditional flow control instruction is logic FALSE. Or the execution unit maintains the predicate counter value to be the same value when the original predicate counter value is not equal to zero. In addition, an address of an instruction immediately following the CALL flow control instruction is pushed into a stack to record a return address.

In the present invention, the depth level counter 520 tracks level of nesting depth, and the predicate counter 507 stores a value to indicate if execution results of instructions in a nested flow block between two flow control instructions (e.g., between IF flow control instruction and ELSE flow control instruction) are allowed to be written back to the register file 509. In other words, after one instruction in the nested flow block is executed to generate a result, the result is not written back to the register file 509 if the predicate counter value is not equal to zero. Therefore, referring to the register value stored in the predicate counter 507 when executing instructions at the specific depth level tracked by the depth level counter 520, the disclosed nested flow control scheme can easily identify if the execution results of the instructions are written back to the register file 509 or dumped, thereby solving the nested flow control problem of the conventional SIMD processor.

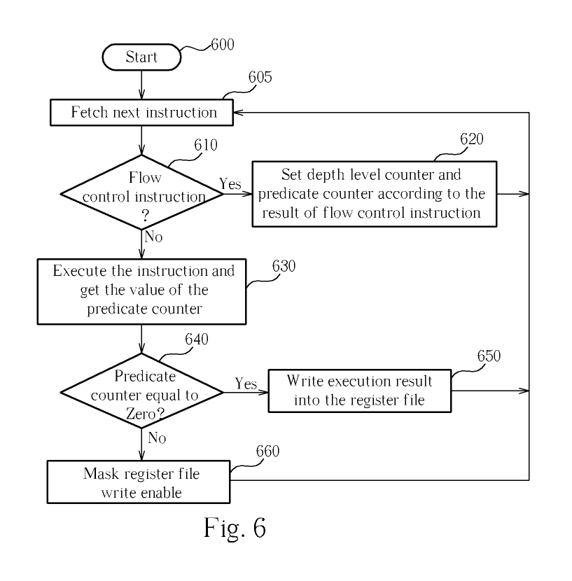

Please refer to FIG. 6. FIG. 6 is a flowchart illustrating a method according to the second embodiment of the present invention shown in FIG. 5 not supporting an early-out option.

Step 600: Start.

Step 605: Fetch next instruction.

Step 610: Is the fetched instruction a flow control instruction? If yes, then go to step 620. If no, then go to step 630.

Step 620: Set the respective depth counter value and the predicate counter value according to the result of the flow control instruction. Go to step 605.

Step 630: Execute the instruction and get the value of the predicate counter from the predicate counter.

Step 640: Is the predicate counter value equal to zero? If yes, then go to step 650. If no, then go to step 660.

Step 650: Write the result into the register file. Go to step 605.

Step 660: Mask the register file to prevent writing to the register file. Go to step 605.

The flow above illustrates the second embodiment of the present invention. Pleases note that the flow begins with step 600. Next, in step 605 a new instruction is fetched. Next, in step 610, it is determined if the fetched instruction a flow control instruction or not a flow control instruction. If the fetched instruction is a flow control instruction (e.g., IF, LOOP, REP) then the flow continues to step 620 otherwise the flow goes to step 630.

In step 620, it has been determined that the current instruction fetched is a flow control instruction. Therefore, it is necessary to set the depth counter value and the predicate counter value according to the result of the flow control instruction. The rules of setting the predicate counter value are described above, and further description is omitted here for brevity. As to setting the depth level counter value, the instruction fetch/decode unit 530 of the processing system 500 of the present invention modifies the value of the depth level counter value stored in the depth level counter 520 each time a flow control instruction is fetched or decoded by the instruction fetch/decode unit 530 in the same way as has been previously described with respect to the execution unit 330 of the processing system 300 of the present invention. For example, an entrance flow control instruction, such as an IF flow control instruction, makes the depth level counter value shift or increase forward, and a termination flow control instruction, such as an ENDIF flow control instruction, makes the depth level counter value shift or decrease backward. The details are not repeated hereinafter.

Next, in step 630, the execution unit 530 executes the instruction and gets the value of the predicate counter value from the predicate counter 507. Next, in step 640, if the predicate counter value is equal to zero then the flow goes to step 650 otherwise the flow goes to step 660. Next, in step 650, if the result of the current instruction evaluation is logic TRUE then the result is written to the register file 509 using a combination of the flow control unit 540 and the write-back unit 508. The flow then continues to step 605. If, however, the evaluation result is logic FALSE, then in step 660, the register file 509 write enable is masked under the control of the flow control unit 540 and no result is written back to the register file 509. Finally, the flow returns to step 605 to fetch the next instruction.

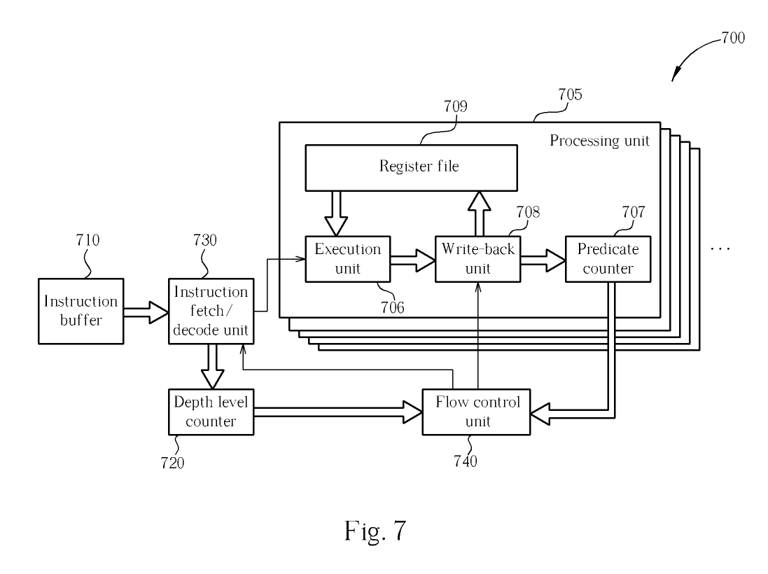

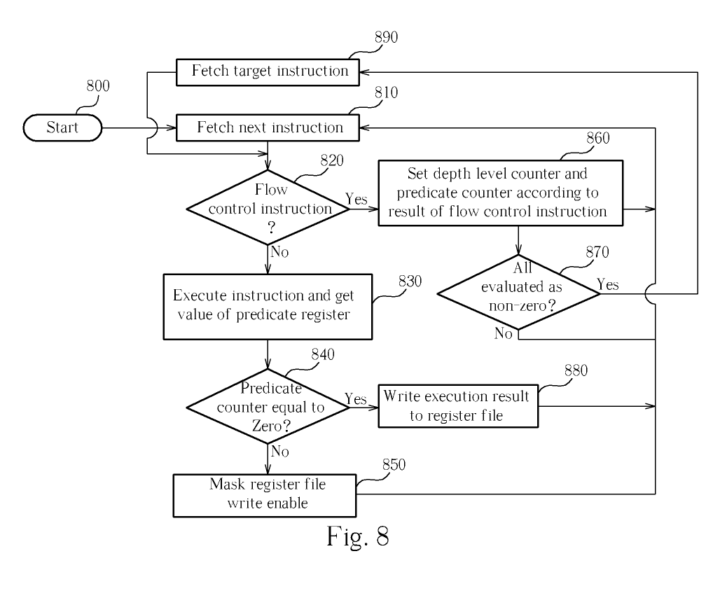

Please refer to FIG. 7. FIG. 7 is a block diagram according to a second embodiment of the present invention supporting an early-out option. The present invention embodiment of FIG. 7 is the same of that illustrated in FIG. 5 but the control paths as illustrated in FIG. 3. One of average skill in this art can easily understand the difference between the embodiments of FIGS. 5 and 7 by referencing FIGS. 1 and 3 and related description mentioned above. Furthermore, in this embodiment at least a specific flow control instruction of the flow control instructions includes a target address, and the next instruction executed by the execution unit 706 is an instruction at the target address when an early-out condition is met. The early-out condition can be many conditions. The present invention does not provide any limitation in this regard. Further description is omitted here for brevity. FIG. 8 is a flowchart illustrating a method according to the second embodiment of the present invention shown in FIG. 7 supporting an early-out option. If there are N processing units 705, and all N processing units 705 evaluate respective predicate counter as non-zero, and then it is not necessary to process the following instructions until the instruction with the corresponding flow control termination instruction is fetched. One of average skill in this art can easily understand the difference between the flows of FIGS. 6 and 8 by referencing FIGS. 2 and 4 and related description mentioned above. Further description is omitted here for brevity.

Regarding the embodiment in FIG. 1 not supporting early-out option and the embodiment in FIG. 3 supporting early-out option, each processing unit has a plurality of predicate registers to record evaluation results of flow control instructions corresponding to different depth levels, and the processing system has a plurality of branch registers corresponding to different flow control instruction types. An execution result of an instruction following a flow control instruction is dumped when a predicate register value corresponding to a specific depth level is logic FALSE. As to the embodiment in FIG. 5 not supporting early-out option and the embodiment in FIG. 7 supporting early-out option, the processing system has a depth level counter to track nesting level, and each processing unit has a single predicate counter set according to one of the depth level counter value and a predetermined number (i.e., zero). An execution result of an instruction following a flow control instruction is dumped when the predicate counter value is not zero. In this way, applying the disclosed nested flow control to an SIMD processor by using the branch register in conjunction with the predicate register or using the depth level counter in conjunction with the predicate counter offers significant improvements over the prior art in solving the problems as cited in the prior art section earlier. It should be noted that applying the disclosed nested flow control to an SIMD processor is only meant to be taken as an example, and is not meant to be a limitation of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for nested flow control, the method comprising:
providing at least a predicate register and a branch register;
receiving a plurality of instructions including flow control instructions;
storing a depth level with the branch register each time a flow control instruction is fetched or decoded or executed;
setting the predicate register according to an evaluation result of the flow control instruction; and
executing instructions following the flow control instruction according to the predicate register and the branch register.

2. The method of claim 1, further comprising:
storing the depth level with the branch register each time a termination instruction corresponding to the flow control instruction is fetched or decoded or executed.

3. The method of claim 1, wherein each type of flow control instructions has a corresponding branch register.

4. The method of claim 1, wherein the flow control instruction includes a target address, and the step of executing instructions following the flow control instruction further comprises executing a next instruction at the target address directly when an early-out condition is met.

5. The method of claim 1, wherein the step of executing instructions following the flow control instruction according to the predicate register further comprises:
if the predicate register is logic TRUE, writing execution results of the instructions following the flow control instruction into a register file; and
if the predicate register is logic FALSE, masking the register file to prevent writing the execution results to the register file.

6. A method for nested flow control, the method comprising:
(a) providing at least a predicate counter and a depth level counter;
(b) receiving a plurality of instructions including flow control instructions;
(c) storing a depth level with the depth level counter each time a flow control instruction is fetched or decoded or executed;
(d) setting the predicate counter according to at least one of a predetermined number and the depth level counter according to an evaluation result of the flow control instruction; and
(e) executing instructions following the flow control instruction according to the predicate counter and the depth level counter.

7. The method of claim 6, further comprising:
(f) setting the predicate counter each time a termination instruction corresponding to the flow control instruction is executed; and
(g) storing the depth level with the depth level counter each time a termination instruction corresponding to a flow control instruction is fetched or decoded or executed.

8. The method of claim 7, wherein the predetermined number is zero, and step (f) further comprises:
setting the predicate counter each time an ELSE termination instruction corresponding to the flow control instruction is executed, wherein the predicate counter is set to the depth level counter when the predicate counter equals zero or setting the predicate counter to zero when the predicate counter equals the depth level counter or when the predicate counter does not equal zero and the predicate counter does not equal the depth level counter maintaining the predicate counter to be the same value.

9. The method of claim 7, wherein the predetermined number is zero, and step (f) further comprises:
setting the predicate counter each time an ENDIF termination instruction corresponding to the flow control instruction is executed, wherein the predicate counter is set to zero when the predicate counter equals the depth level counter or when the predicate counter does not equal the depth level counter maintaining the predicate counter to be the same value.

10. The method of claim 7, wherein the predetermined number is zero, and step (f) further comprises:
setting the predicate counter each time a RET termination instruction corresponding to the flow control instruction is executed, wherein the predicate counter is set to zero when the predicate counter equals the depth level counter or when the predicate counter does not equal the depth level counter maintaining the predicate counter to be the same value.

11. The method of claim 6, wherein the flow control instruction includes a target address, and step (e) further comprises executing a next instruction at the target address directly when an early-out condition is met.

12. A processing system having nested flow control, the processing system comprising:
an instruction buffer for receiving and storing a plurality of instruction including flow control instructions;
at least a branch register, for storing a depth level each time a flow control instruction is fetched or decoded or executed;
a processing unit, coupled to the instruction buffer, comprising:
at least a predicate register each representing an execution status of a corresponding depth level; and
an execution unit, for executing the instructions, wherein the predicate register is set according to an evaluation result of the flow control instruction executed by the execution unit and a current depth level;
a flow control unit, coupled to the branch register and the predicate register, for controlling the execution unit to execute instructions following the flow control instruction according to the predicate register.

13. The processing system of claim 12, wherein the branch register stores the depth level each time a termination instruction corresponding to the flow control instruction is fetched or decoded or executed by the execution.

14. The processing system of claim 12, wherein the flow control instruction includes a target address, and the execution unit executes a next instruction at the target address directly when an early-out condition is met.

15. The processing system of claim 14, wherein the early-out condition is met if each predicate register indexed by the branch register corresponds to a logic value making branch taken according to the evaluation result of the flow control instruction.

16. A processing system having nested flow control, the processing system comprising:
at least a predicate counter, for storing a predicate counter value;
an instruction fetch/decode unit, for receiving, storing, and decoding a plurality of instructions including flow control instructions;
a depth level counter, coupled to the instruction fetch/decode unit, for storing a depth level counter value;
a flow control unit, coupled to the depth level counter and coupled to the predicate counter, for tracking a depth level with the depth level counter value each time a flow control instruction is fetched or decoded or executed; and
an execution unit, for setting the predicate counter according to at least one of a predetermined number and the depth level counter according to an evaluation result of the flow control instruction; and for executing instructions following the flow control instruction according to the predicate counter and the depth level counter.

17. The processing system of claim 16, wherein the execution unit further sets the predicate counter each time the execution unit executes a termination instruction corresponding to the flow control instruction; and sets the depth level counter each time each time a termination instruction corresponding to a flow control instruction is fetched or decoded or executed.

18. The processing system of claim 16, wherein the flow control instruction includes a target address, and the execution unit executes a next instruction at the target address directly when an early-out condition is met.

19. The processing system of claim 18, wherein the early-out condition is met if each predicate counter stores the predetermined number making branch taken according to the evaluation result of the flow control instruction.

20. The processing system of claim 16, further comprising:
a register file; and
a write-back unit, controlled by the flow control unit, wherein if the predicate counter records the predetermined number, the flow control unit controls the write-back unit to write execution results of the instructions following the flow control instruction into the register file; and if the predicate counter does not record the predetermined number, the flow control unit masks the register file to prevent the write-back unit from writing the execution results to the register file.
